(19) United States
(12) Patent Application Publication
(10) Pub. No.: US 2003/0129328 A1
(43) Pub. Date: Jul. 10, 2003

(54) Method for producing a layer which influences the orientation of a liquid crystal and a liquid crystal cell having at least on layer of this type

(76) Inventors: Wolfgang Dultz, Frankfurt am Main (DE); Arkady Onokhov, Petersburg (RU); Wolfgang Haase, Reinheim (DE); Elena Konshina, St. Petersburg (RU); Thomas Weyrauch, Columbia, MD (US)

Correspondence Address: KENYON & KENYON, ONE BROADWAY, NEW YORK, NY, 10004, US

(21) Appl. No.: 10/169,043

(22) PCT Filed: Dec. 2, 2000
(86) PCT No.: PCT/EP00/12133

(30) Foreign Application Priority Data
Dec. 23, 1999 (DE) 199 62 306.6

(51) Int. Cl. C09K 19/00

(52) U.S. Cl. 428/1.2

(57) ABSTRACT

To reduce the disadvantages of conventional liquid-crystal orientation layers, or of liquid crystal cells having such layers, it is proposed to deposit the orientation layer on a substrate from a plasma of a gas discharge, the gas having at least one hydrocarbon, particularly a monomeric hydrocarbon.

The method of the present invention allows the angle of tilt of the liquid crystals adjacent to the orientation layer to be defined and reproducibly adjusted, thus improving the contrast and the rise time of light modulators.

The present invention relates to a method according to the preamble of claim 1 and a device according to the preamble of claim 7.

Liquid crystals are used today in a multitude of devices, such as in displays, shutters, light valves, deflectors and waveguides.

Spatially-resolving light modulators function as light valves and are able to process optically or electrically existing, two-dimensional information, such as images or patterns, in parallel, as is necessary in particular for optical information processing and optical pattern recognition. Depending on the type of spatially-resolving light modulator, it may include a nematic or smectic, planar liquid layer which is disposed either between transparent electrodes or adjacent to a photoconductive semiconductor layer. The principle of such light modulators is based on the effect of a possibly spatially-dependent electric field on the liquid crystal, whose birefringent properties thereby change as a function of space by way of an electro-optical effect. In the case of an electrically controlled light modulator, e.g. a phase modulator, the electric field is generated by structurally formed electrodes, and in the case of the optically controlled light modulator, by the structured illumination of a photoconductor.

In most cases of the optical devices mentioned having liquid crystals, a uniform molecular orientation must be predefined. For example, if a nematic liquid-crystal layer has a long-range order of the molecular orientation, the position of the so-called director which describes the spatial mean value of this orientation is, however, indefinite, and must be set from outside. This is achieved by a liquid-crystal orientation layer against which the liquid crystal abuts, the layer establishing a predefined orientation direction which determines the orientation of the director of the liquid-crystal molecules.

A multitude of methods are known for producing such an orientation layer. For example, plastic layers may receive a privileged direction by linear rubbing with absorbent cotton (UK 1372 868) or by particle bombardment, or by the use of optical techniques (FR 2206981). Furthermore, the inclined deposition of thin films (UK 14011404) or even the inclined vapor-deposition of coatings in vacuum (UK 1388077) have been suggested for orienting the molecules. The orientation layers according to the related art may be made of polyimide resins (FRG 263 8091), cellulose (FRG 2431482) [and] polymers doped with butyl cellulose (JP 4-81167), and are deposited from suitable solutions. In the U.S. Pat. No. 4,038,441, long-chain polymer molecules are deposited onto a substrate from a monomer vapor at a grazing incidence. Moreover, orientation layers are known using liquid monomers from the groups of methyl methacrylates, vinyl monomers, silanes, chlorosilanes and siloxanes; the polymer may also be vaporized directly in vacuum (JP 5-21214), and as a rule, the substrate onto which the orientation layer is deposited must be heated to the polymerization temperature.

It has been established that too strong a planar orientation of the liquid crystal molecules, i.e. parallel to the surface of the orientation layer, can reduce the efficiency of the modulator. This is also attributable to the fact that, given too strong an orientation of the molecules parallel to the surface of the orientation layers, they are hindered, particularly near the orientation layer, from reorienting themselves on the basis of an electric field applied from outside, which also diminishes the achievable visual contrast. Furthermore, the formation of domains near the substrate, or simply the perpendicular relative position of the acting electric field with respect to the director can hinder or even prevent reorientation of the liquid crystals in the applied electric field, above all in the vicinity of the orientation layer.

It is therefore frequently advantageous for the planar orientation of liquid crystals if the orientation direction of the director predefined by the orientation layer has, in addition to a component parallel to the substrate plane or orientation-layer plane, a component perpendicular to this plane, as well, and thus the director of the oriented molecules is easily tilted out of the substrate plane, the optimal angle of tilt Θ being dependent, for example, on the liquid crystals used. However, the orientation layers produced by the methods described and having the conventional compositions are unable, in particular, to provide a defined and reproducible adjustment of the angle of tilt.

Therefore, the object of the present intention is to at least reduce the described disadvantages of liquid-crystal orientation layers, or liquid-crystal cells which have such layers.

It is already achieved by a method for producing a liquid-crystal orientation layer on a substrate by deposition in a plasma of a gas discharge, and by a liquid crystal cell which has at least one such orientation layer. For this purpose, the layer is deposited by gas discharge from a gas which has at least one hydrocarbon, particularly a monomeric hydrocarbon. Highly surprisingly, by the use of at least one hydrocarbon, particularly a monomeric hydrocarbon for producing the discharge plasma, it is possible to define and reproducibly adjust the orientation direction of the layer deposited in the plasma of the gas discharge, and thus the angle of tilt of the adjacent liquid crystals. In this context, the angle of tilt optimized for the specific liquid crystals may be adjusted while producing the orientation layer, by stipulation of the hydrocarbon, the angle α between the substrate plane and the average flow direction of the plasma ions, and the discharge power W. For cyanobiphenyls, deposition angles α between approximately 5° and 10° and direct-current discharge powers between 1.6 and 1.8 W have proven to be particularly advantageous.

For example, using orientation layers according to the present invention, it is possible to produce modulators having a high contrast and a lower response time in comparison to modulators according to the related art.

A multitude of substances which are usually readily available and are not cost-intensive, e.g. toluene vapor, benzole vapor, octane vapor or a mixture of these may be used as monomeric hydrocarbon for producing the plasma. Since, in addition, conventional standard vacuum installations may be used for depositing the layers, and the heating of the substrate during the deposition may be omitted, the layers and liquid crystal cells of the present invention may be produced very conveniently industrially.

The deposited layers include essentially hydrocarbon polymers which scarcely absorb, and furthermore, are insulating. The high surface energy of the layers allows a stable, planar orientation of the liquid-crystal molecules because of intermolecular forces at the contact layer between the deposited orientation layer and the liquid crystals.

The reproducible and defined adjustment of the angle of tilt by the deposition of the orientation layer according to the present invention is also possible in the case of a coating in contact onto a transparent, conductive electrode layer, a photoconductive semiconductor layer, a light-reflecting layer or even directly onto the substrate. In so doing, the properties of the layers situated below the orientation layer of the present invention, e.g. a transparent electrode or a photo-semiconductor layer, are advantageously not changed. Thus, all liquid crystal cells, particularly transmittive and reflective modulators, may be produced using orientation layers manufactured according to the present invention.

To take advantage of the so-called S-effect, the mutually facing substrates surrounding the liquid crystal may each have an orientation layer, which are oriented such that the two orientation directions are parallel to each other.

To utilize the so-called twist effect, the substrates having the respective orientation layers may be arranged relative to each other in such a way that the two orientation directions are at right angles to each other. To achieve a high contrast, both substrates of the

“S”-liquid crystal cell of the invention may have an orientation layer according to the present invention, angle α being set to approximately 90° during the coating of the first substrate, and to approximately 10° during the coating of the second substrate. To adjust a low response time of the “S”-liquid crystal cell, both orientation layers may be deposited at an angle of α approximately 10°.

The use of a liquid-crystal orientation layer, produced according to the present invention, for an optically addressable, particularly spatially-resolving modulator or an electrically addressable, particularly spatially-resolving modulator is only by way of example; in principle, the liquid-crystal orientation layer of the present invention may be used for all known liquid crystal cells.

In the following, the invention is clarified by the description of several specific embodiments, taking the drawings as a basis, in which:

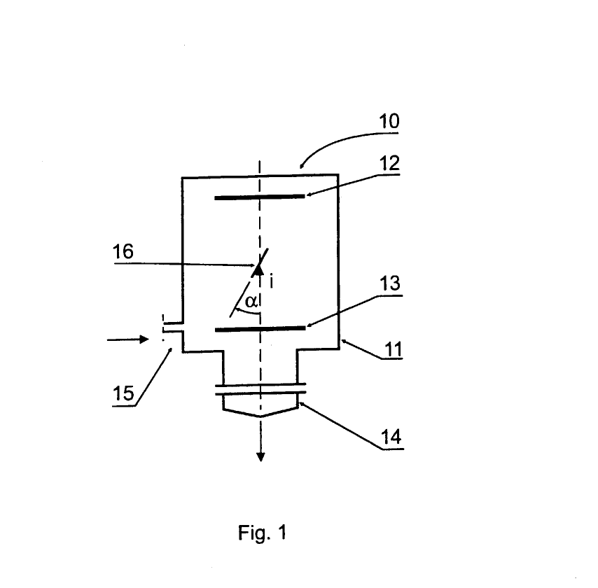

FIG. 1 shows the coating installation in a schematic sketch;

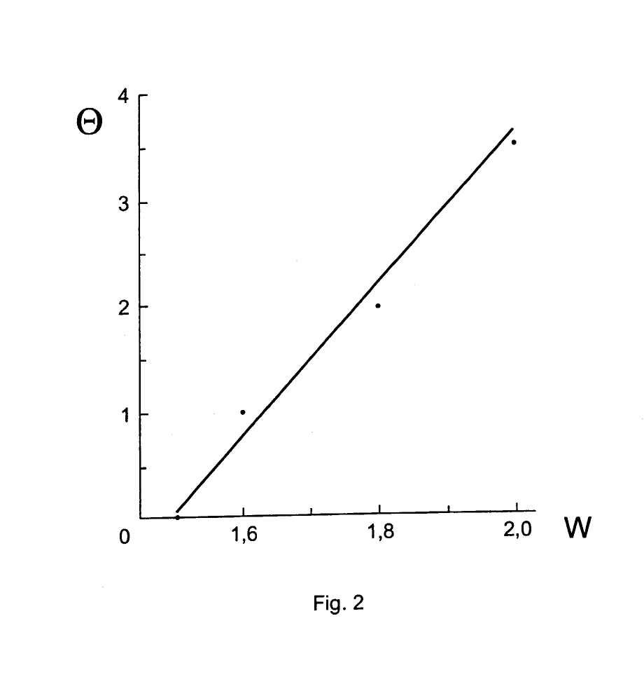

FIG. 2 shows the measured angle of tilt Θ as a function of the discharge power, given a fixed deposition angle α;

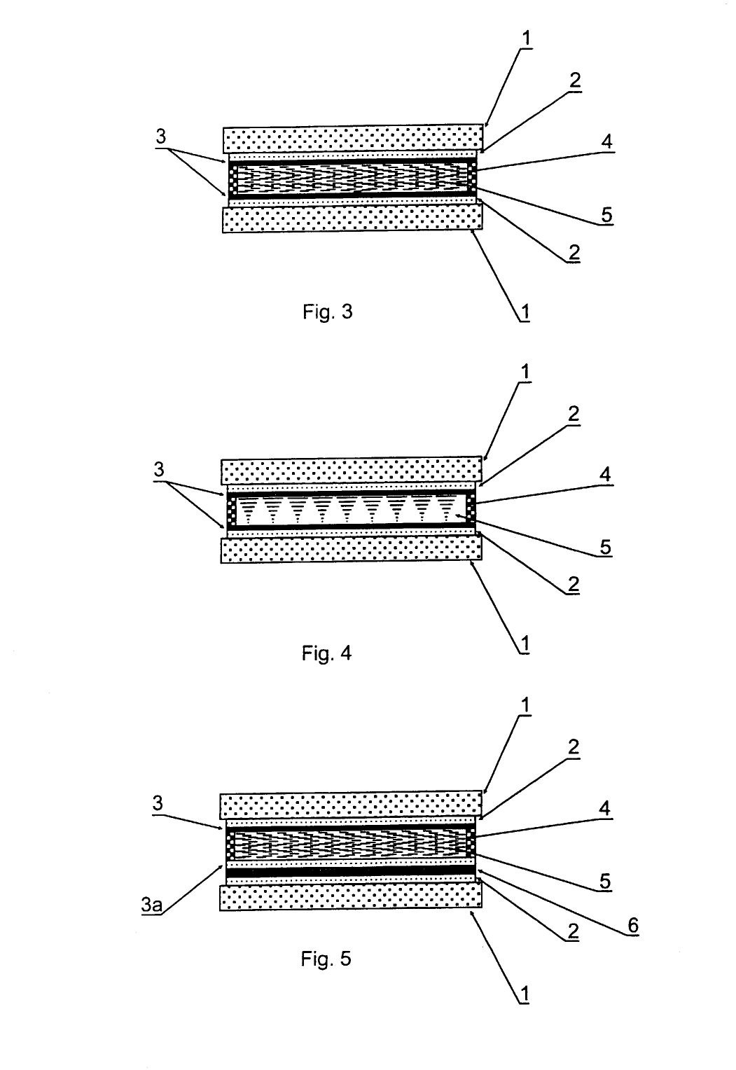

FIG. 3 shows an electrically controllable modulator for utilizing the S-effect;

FIG. 4 shows an electrically controllable modulator for utilizing the twist effect;

FIG. 5 shows an optically addressable, spatially-resolving modulator; and

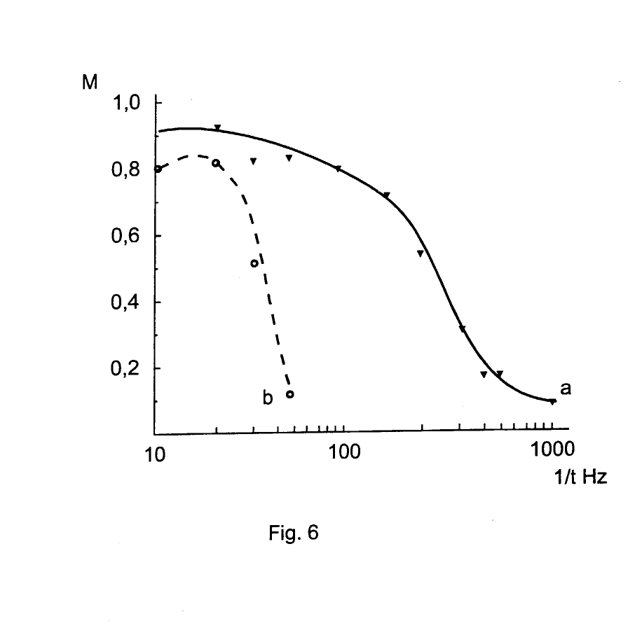

FIG. 6 shows the measured modulation transfer factors of two modulators according to the type of construction shown in FIG. 3.

FIG. 1, in a schematic representation, shows an apparatus for carrying out the method of the present invention for producing a liquid crystal orientation layer on a substrate by the deposition of atoms, molecules and/or polymers from a plasma of a gas discharge in the form of a glow discharge. It has a chamber 11 which may be evacuated of air by a pump (not shown) connected to connection piece 14. Arranged set apart from each other in vacuum chamber 11 are a cathode 12 and an anode 13, between which a high voltage is applied. The discharge gas is fed to vacuum chamber 11 via a filler stub 15, and in the example described, includes a monomeric hydrocarbon in the form of toluene vapor. Positioned between the anode and the cathode is a substrate holder 16 which is mounted in a manner permitting it to swivel about an axis situated perpendicular to the drawing plane.

Producing a gas discharge in the apparatus described is well-known to one skilled in the art, so that there is no need to discuss it in the following. The result of the gas discharge is a stream of ions and electrons between the two electrodes 12, 13, the spatially-averaged flow direction of charge carriers being designated as vector i. To coat a substrate, the substrate is received by substrate holder 16. The charge carriers, i.e. ions from the plasma of the toluene vapor, strike the substrate at a predefined angle α and are deposited essentially as dielectric hydrocarbon polymer or polymers on the substrate. In this context, the orientation direction lies within the plane defined by vector i and the surface normals of the substrate, i.e. in the drawing plane of FIG. 1. The angle of tilt, that is to say, the orientation of the director of the predefined liquid crystal from the orientation layer is established, depending on the selection of the hydrocarbon for the glow discharge, on the one hand by the adjustment of angle α, the angle between flow direction i and the substrate plane, and by the adjustment of the discharge power. The otherwise customary and necessary heating of the substrate may be omitted for the deposition of the orientation layer according to the present invention, and the deposition may be carried out at room temperature.

FIG. 2 shows the illustrative dependence of angle of tilt Θ on discharge power W for a 10 μm thick liquid crystal cell of the S type having cyanobiphenylene, both orientation layers having been produced at a predefined angle α=10°. The angle of tilt runs within a range between approximately 1.3 and 2.0 watts linearly with the discharge power, and for the discharge powers indicated, lies in the range from 0 to approximately 3.5°.

If angle α is approximately 90°, then no plane is defined, since the irradiation plane of the stream of charge carriers is reduced to a straight line; therefore, no orientation direction is defined through the orientation layer.

Depending on the specific embodiment of the invention, various monomeric hydrocarbons, liquid or gaseous under normal conditions, such as toluene, benzole, octane, etc., may be used for producing the plasma or the substances to be deposited on the substrate. In all cases, the orientation layer produced are homogeneous and transparent in the visible spectral region; the extinction coefficient lies between 0.01 and 0.03. The refractive index of the layers produced is between 1.5 and 1.6. The layers are highly insulating, having a surface resistance of greater than 10¹² Ωcm. The high surface energy of the layers of approximately 43 J/m² allows a stable, essentially planar orientation of the liquid crystal molecules as a result of the intermolecular forces at the contact layer between the orientation layer and the liquid crystals. Due to the orientation layer of the present invention, given a deposition angle of α=5°-10° and discharge powers of 1.6 to 1.8 watts, the director of the liquid crystals is tilted out of the substrate plane by a small angle of tilt Θ; for a liquid crystal based on cyanobiphenylenes having a thickness of 10 μm, by 0° to 2°. At an increased glow discharge power of 2.2 watts, angle of tilt Θ of the liquid crystal director increases by not more than 3.5°.

FIG. 3 shows an electrically addressable modulator which operates on the basis of the so-called S-effect. In this case, the liquid crystal cell of the present invention includes two glass substrates 1 of 35 mm diameter, upon which in each case a transparent electrode 2 of indium-tin-oxide is deposited. An orientation layer 3 according to the invention was deposited on the transparent electrode from the toluene vapor in the plasma of a glow discharge. Angle α was set to 10° for both orientation layers, see FIG. 1. The two glass substrates are arranged oriented relative to each other in such a way that the orientation directions, i.e. the privileged directions for the director of the liquid crystals, are parallel. Spacers 5 made of Teflon having a thickness of 5 μm, together with the substrates, define a volume into which a liquid-crystal mixture of cyanobiphenylenes in the isotropic phase is poured through a hole according to the known capillary technique. The cell was sealed by an epoxy cement at the edges. The application of an electric field in a known manner to the electrodes reorients the molecules in the electric field, such that, from their position parallel to the substrate or the orientation layer, they are positioned perpendicular thereto, the optical anisotropy, and with it, the birefringence thereby being canceled. The operating frequency of the modulator was determined by measuring the time interval between applying the operating voltage and reaching an image contrast of 0.8 to 0.9 of the maximum value during continuous operation. In a similar manner, upon switching off the voltage, the time duration was determined after which the image contrast had fallen to 0.1 to 0.2 times the maximum value. The switch-on time thus determined was 200 μsec; the switch-off time was 20 msec.

Curve a) in FIG. 6 shows the dependence of the modulation transfer factor on the applied frequency for the electrically addressable modulator shown in FIG. 3. If both orientation layers are applied at angle α=10°, given a glow-discharge power of 1.5 W, then at 250 Hertz, a modulation transfer factor of M=0.5 results, and at 1000 Hertz, a modulation transfer factor of M=0.1 results.

If, on the other hand, one of the two layers is instead deposited at an angle of α=90°, then a higher contrast results; however, the corresponding frequencies decrease to 30 Hz for M=0.5 and 50 Hz for M=0.1, see curve b) of FIG. 6. The time constants for electrically and optically addressable modulators do not differ significantly.

FIG. 4 shows the structure of an electrically addressable modulator based on the so-called twist effect. It differs from the modulator shown in FIG. 3 only in that the two orientation directions of the layers are perpendicular to one another, so that in the progression from the one boundary layer to the other, the liquid crystals complete a 90° rotation. Accordingly, in FIG. 4, the director of the liquid crystals at the lower boundary layer is perpendicular to the drawing plane, while in the upper boundary layer, it is parallel to the drawing plane. Light which is transmitted through the modulator rotates its polarization according to the rotation of the liquid crystals, while in response to the application of an electric voltage, the molecules are again reoriented in the normal direction with respect to the substrate surface, the need for rotating the transmitting light thereby being eliminated. It was determined that liquid crystal cells formed according to the present invention exhibit a fixed anchoring and orientation of the liquid crystals. In response to square-wave pulses having an amplitude of 20 volts and a duration of 2 msec, a switch-on time of 50 μsec and a switch-off time of 100 μsec were measured.

FIG. 5 shows the structure of an optically addressable modulator based on the S-effect. A substrate 1 again includes a transparent electrode 2 upon which an orientation layer 3 of the present invention, like that in FIG. 3, was applied. The other glass substrate was again provided with a transparent electrode 2 upon which a polymer photo-semiconductor layer 6 was vapor-deposited, upon which an orientation layer according to the invention was deposited from a toluene vapor in plasma at normal incidence, i.e. α=90°. Moreover, the cell shown in FIG. 5 corresponded in its technical design to the liquid crystal cell shown in FIG. 3. Accordingly, the liquid crystal layer exhibited a uniform parallel orientation as long as the photoconductor was not illuminated from its rear side, that is, from below in the drawing, for example, by imaging a grating. To measure the time constants, a voltage in the form of a square-wave pulse having an amplitude of 30 volts and a time duration of 20 msec was applied to the electrodes during the illumination of the photoconductor, the repetition rate having been 2 Hz. The rise time for reaching 0.1 to 0.9 times the maximum diffraction efficiency was 500 msec, and the corresponding descent time for reaching 0.9 to 0.1 times the maximum diffraction efficiency was determined at 20 msec. Due to the orientation layers of the present invention, the response times of the modulators are shortened compared to modulators according to the related art.

The quality of the functioning of modulators produced in this manner make their use in optical information processing, light detection, light transmission and light amplification attractive.

What is claimed is:

1. A method for producing a liquid crystal orientation layer (3, 3a) on a substrate (1) by deposition from a plasma of a gas discharge,
wherein the layer is deposited from a gas which includes hydrocarbon, particularly monomeric hydrocarbon.

2. The method as recited in claim 1,
wherein the gas discharge is a glow discharge, the angle α between the substrate plane and an average flow direction i of the discharge current being set to 0° to 90°, preferably 5° to 10°.

3. The method as recited in claim 1 or 2,
wherein the angle α is set to approximately 5° to 10°, and the discharge power for attaining an angle of tilt Θ of 0 to 3.5 degrees is set between 1.4 and 2.2 W.

4. The method as recited in claim 1, 2, or 3,
wherein a toluene vapor, a benzole vapor and/or an octane vapor is used as hydrocarbon.

5. The method as recited in claim 1, 2, 3, or 4,
wherein the orientation layer (3, 3a) in contact is deposited onto a transparent, conductive electrode layer (2), a photoconductive semiconductor layer (6) or a light-reflecting layer, with which in each case the substrate is coated.

6. A substrate having a liquid crystal orientation layer according to one of the methods as recited in one of claims 1 through 5.

7. A liquid crystal cell comprising a volume, formed by two flat-extending, set-apart substrates (1) and at least one spacer element (5), in which a predefined quantity of liquid crystal (4) is disposed, and at least one substrate is transparent,
characterized by at least one substrate (1) having a liquid-crystal orientation layer (3, 3a) which includes at least one hydrocarbon polymer, particularly a substrate having a liquid-crystal orientation layer according to claim 6, the liquid crystal orientation layer (3, 3a) being disposed on the side facing the liquid crystal (4).

8. The liquid crystal cell as recited in claim 7,
wherein both substrates (1) have an orientation layer (3, 3a), the substrates being arranged in such a way that the respective orientation direction of the orientation layers are essentially parallel to one another.

9. The liquid crystal cell as recited in claim 7,
wherein both substrates (1) have an orientation layer (3, 3a), the substrates being arranged in such a way that the respective orientation direction of the orientation layers are at right angles to one another, essentially in the substrate plane.

10. The liquid crystal cell as recited in claim 7,
wherein both substrates (1) have an orientation layer (3, 3a), the angle α during the deposition onto the first substrate being set to approximately 90 degrees, and during the deposition onto the second substrate being set to approximately 5° to 10°.

11. The liquid crystal cell as recited in one of claims 7 through 10,
wherein the cell is constructed as an optically addressable, in particular spatially-resolving modulator, and the first substrate (1) has, starting from it, the applied layers: transparent, electroconductive electrode layer (2), photoconductive semiconductor layer (6) and liquid-crystal orientation layer (3a); and the second substrate (1) has, starting from it, the applied layers: electroconductive electrode layer (2) and liquid-crystal orientation layer (3).

12. The liquid crystal cell as recited in one of claims 7 through 10,
wherein the cell is constructed as an electrically addressable, in particular spatially-resolving modulator, and the two substrates (1), starting from the respective substrate, have the applied layers: transparent, electroconductive electrode layer (2) and liquid-crystal orientation layer (3).
